(19) United States
(12) Patent Application Publication
(10) Pub. No.: US 2007/0068065 A1
(43) Pub. Date: Mar. 29, 2007

(54) MOLE TRAPPING SYSTEM, MOLE TRAP AND TRAP-SETTING ASSISTANCE DEVICE, AND METHODS OF CONSTRUCTING AND UTILIZING SAME

(76) Inventor: Elgin Glen Brown JR., Mio, MI (US)

Correspondence Address: Irving M. Weiner;Weiner & Burt, P.C., 635 N. US-23, P.O. Box 186, Harrisville, MI, 48740, US

(21) Appl. No.: 11/532,292

(22) Filed: Sep. 15, 2006

Related U.S. Application Data
(60) Provisional application No. 60/596,490, filed on Sep. 28, 2005.

(51) Int. Cl. A01M 23/36

(52) U.S. Cl. 43/80; 43/77; 43/79

(57) ABSTRACT

A mole trap having a bottom frame with spikes beneath it above a mole tunnel. A top frame is slidably connected to the bottom frame. A spring mechanism is positioned between the top and bottom frames. Two U-shaped members are placed in the ground extending beneath the mole tunnel. A movable trigger mechanism extends in the vicinity of the mole tunnel. The trigger mechanism is instantly tripped when a mole or earth moved by the mole touches a portion of the trigger mechanism, and thrusts the two U-shaped members upwardly with the mole to impale the mole on spikes.

### CROSS-REFERENCE TO RELATED APPLICATIONS

The present application is a continuation-in-part of and claims priority from U.S. Provisional Patent Application Ser. No. 60/596,490 filed Sep. 28, 2005.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates to a mole trapping system, a mole trap and a trap-setting assistance device, and methods of constructing and utilizing same.

More particularly, the present invention relates to a mole trapping system and a mole trap having a substantially horizontally-arranged spring mechanism which thrusts two U-shaped members upwardly carrying the mole to impale the mole on a plurality of spikes.

Many ineffective methods have been used in an attempt to get rid of moles. For example, one such ineffective method is running a hose into a mole tunnel, which invariably results in turning a lawn into a rice paddy.

Another ineffective method to get rid of moles is by gassing them with fumes from an automobile exhaust pipe.

On the other hand, some conventional mole traps use scissor jaws, choker loops, and harpoons. Each of such mole traps has disadvantages.

The prior, but not necessarily relevant, art includes Townsend U.S. Pat. No. 4,776,128; Dahlman U.S. Pat. No. 4,827,662; and Hagen et al. U.S. Pat. No. 6,802,152.

It is a desideratum of the present invention to avoid the animadversions of the conventional and prior art devices and techniques.

### SUMMARY OF THE INVENTION

The present invention provides a mole trap, comprising: a first frame structure having a plurality of spikes rigidly depending therefrom; said first frame structure being adapted to be disposed horizontally on the ground above a mole tunnel; a second frame structure selectively and releasably connected to said first frame structure to slide linearly and vertically relative to said first frame structure; a spring mechanism disposed substantially horizontally between said first frame structure and said second frame structure; said second frame structure including two U-shaped members adapted to be placed in the ground transverse to and extending beneath said mole tunnel, said first frame structure having a movable trigger mechanism at least a portion of which depends from said first frame structure and being adapted to extend in the vicinity of said mole tunnel; said second frame structure including a moveable latch adapted to be engaged with said trigger mechanism when said spring mechanism is compressed; said trigger mechanism being instantly disengaged from said latch when a mole or earth moved by the mole touches a portion of said trigger mechanism, and thereby thrusting said two U-shaped members upwardly with the mole to impale the mole on said spikes.

The present invention also provides device for facilitating a mole trap process and for facilitating setting of the mole trap, wherein said device comprises: a main horizontal platform member from which depends a central hole-cutting member for cutting a substantially vertical hole in the ground into which at least a portion of said trigger mechanism may be disposed; and two depending outer members for cutting slots in the ground to accommodate said U-shaped members.

The present invention further provides a novel mole trapping system, comprising: first means for simultaneously making predetermined slots and a central hole in the ground in proximity to a mole tunnel in the ground; a mole trap which is set by positioning said mole trap on said first means, compressing a spring mechanism of said mole trap, and latching a trigger mechanism of said mole trap; after said mole trap has been set, removing said mole trap from said first means; placing said mole trap over the mole tunnel with components of said mole trap fitting into said predetermined slots made by said first means, and with a portion of said trigger mechanism fitting into said central hole made by said first means; and said trigger mechanism is released when a mole or earth moved by the mole comes in contact with said trigger mechanism sending said components upwardly carrying the mole towards spikes of said mole trap.

It is an object of the present invention to provide a mole trap as described hereinabove, to rid lawns, yards and golf courses of moles, and their tunnels and mounds.

Another object of the present invention is to provide a mole trap as described hereinabove, wherein the mole trap is set in the ground over the mole tunnel.

Yet a further object of the present invention is to provide a mole trap as described hereinabove, wherein the mole trap has a central trigger mechanism which is placed in a vertical hole communicating with the mole tunnel, and which fires very rapidly and kills the mole very quickly.

Another object of the present invention is to provide a mole trap as described hereinabove, wherein the mole trap will pull the mole out of its tunnel with its jaw-like U-shaped members.

A further object of the present invention is to provide a mole trap as described hereinabove, wherein in one embodiment the mole can be traveling in either direction in the mole tunnel and the mole trap will trigger perfectly.

Yet a further object of the present invention is to provide a mole trap having a pan and pushrod in a hole over and communicating with the mole tunnel, which pushrod activates the trigger mechanism.

Further objects, advantages and features of the present invention will become more apparent to those persons skilled in this particular area of technology and to other persons after having been exposed to the detailed description set forth hereinbelow and the accompanying drawings.

### BRIEF DESCRIPTION OF THE DRAWINGS

FIG. 1 illustrates a device for starting the mole trapping process.

FIG. 2 shows a first embodiment of the mole trap having a swingable trigger mechanism showing the mole trap in the set position.

FIG. 3 illustrates the FIG. 2 device after the trigger mechanism has been tripped or activated.

FIG. 4 shows an end view of the FIG. 3 device showing a mole impaled thereon.

FIG. 5 illustrates an alternate embodiment having a trigger mechanism which pushes up.

### DETAILED DESCRIPTION OF THE INVENTION

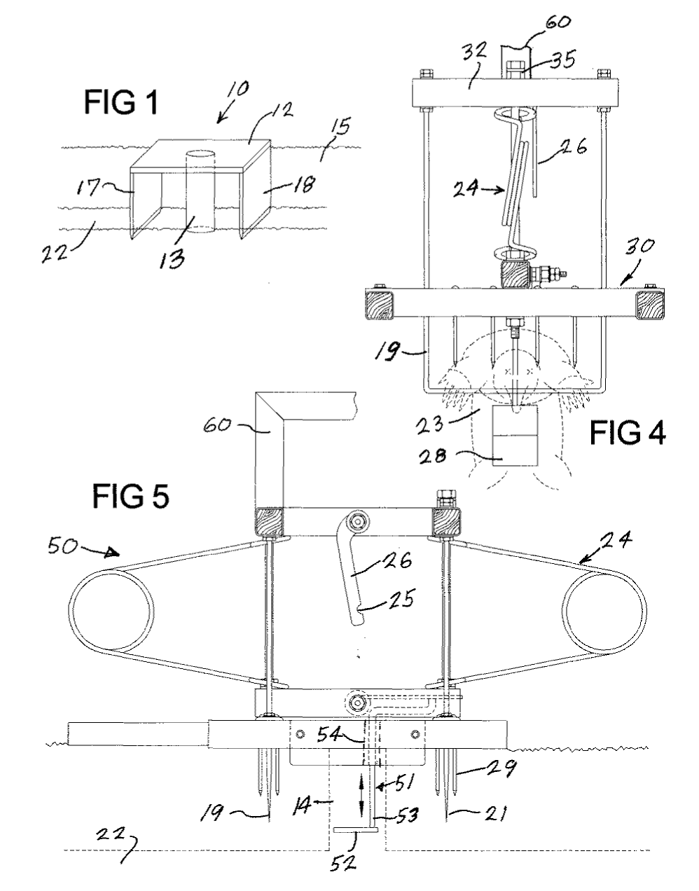

With reference to FIG. 1, there is shown a device 10 for facilitating starting the mole trap process and for facilitating setting of the mole trap 20 or 50.

The device 10 has a main horizontal platform 12 from which depends a central cylindrical hole-cutting member 13 for cutting a hole 14 in the ground 15 into which the trigger 16 or 51 of the mole trap 20 or 50, respectively, may be disposed, and two depending outer members 17 and 18 for cutting slots in the earth to accommodate the U-shaped members 19 and 21 of the mole trap 20 or 50.

The user would first see the track 22 of the mole 23 in the surface of the ground 15, and then position the cylindrical hole-cutting member 13 over the mole track or tunnel 22, and press the device 10 downwardly into the ground 15. This cuts a vertical cylindrical hole 14 into the mole track 22, and at the same time provides two outer slots in the ground 15 to accommodate the U-shaped members 19 and 21 of the mole trap 20 or 50.

The device 10 would then be removed with the earth plug in the cylindrical hole-cutting member 13 and then the earth plug is disposed of. The device 10 can then be repositioned in the ground 15 where the cylindrical hole 14 and slots have been cut to be used as a setting-assistance device 10 to set the mole trap 20 or 50.

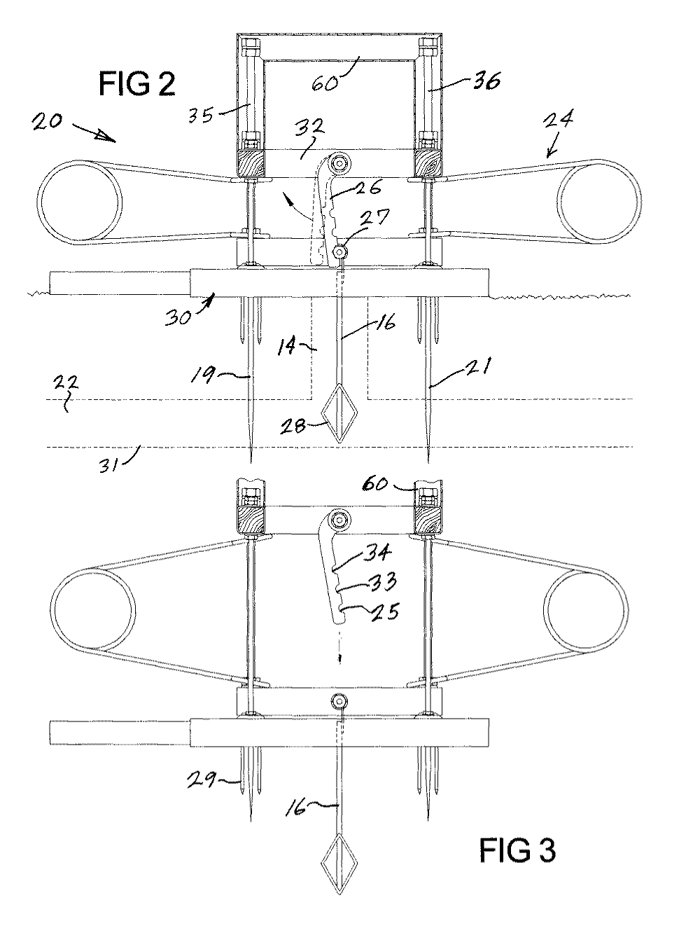

With reference to FIG. 2, the mole trap 20 is set by compressing the horizontally-extending spring mechanism 24 and engaging, preferably, but not necessarily, the lowermost notch 25 of a latch 26 with a mating member 27 to which the swingable pendulum trigger 16 is attached. After the trigger 16 has been set, as illustrated in FIG. 2, the mole trap 20 is removed from the device 10 and placed into the hole 14 and two slots which were made by the device 10 illustrated in FIG. 1.

As shown in FIG. 2, the bottom portion 28 of the trigger 16 is disposed centrally in the mole tunnel 22, and the trigger 16 can swing either way to fire the mole trap 20. Wen the mole 23 comes along in the tunnel 22 and touches the lower portion 28 of the pendulum trigger mechanism 16, the trigger 16 is released from the latch 26, sending the U-shaped members 19 and 21 upwardly carrying the mole 23 with them towards the spikes 29 which depend from the main frame structure 30. The fired condition of the mole trap 20 is illustrated in FIG. 4.

It should be noted from FIG. 2 that the U-shaped members 19 and 21 are adapted to be placed in the ground 15 transverse to and preferably, but not necessarily, extending beneath the mole tunnel 22. By placing the bottom most portions of the U-shaped members 19 and 21 approximately ½ inch below the bottom 31 of the tunnel 22, it prevents the mole 23 from smelling the steel or other metal of the U-shaped members 19 and 21.

It should be noted from FIGS. 2-4 that the main frame structure 30 has a plurality of spikes 29 rigidly depending therefrom, and such frame structure 30 is adapted to be disposed substantially horizontally above the mole tunnel 22.

There is also provided a second frame structure 32 which is selectively and releasably connected to the main frame structure 30 to slide linearly and vertically relative to the main frame structure 30. More particularly, the U-shaped members 19 and 21 are adapted to be placed in the ground 15 transverse to and extending beneath the mole tunnel 22, and said U-shaped members 19 and 21 slide linearly within said main frame structure 30 when the mole trap 20 or 50 is set, and when the mole trap 20 or 50 is triggered or fired.

The latch 26 is affixed pivotably to the second frame structure 32. Although the latch 26 is shown in the drawing with several notches 25, 33 and 34 for engaging with the upper portion 27 of the trigger 16, only one notch is necessary for the mole trap 20 to work properly.

With respect to FIG. 5, there is shown an alternate embodiment in the form of a mole trap 50 having a different trigger mechanism 51 comprising a pan 52 which is adapted to be disposed in the cylindrical hole 14 over the mole tunnel, the pan 52 is connected to a pushrod 53 movable in a guide tube 54 to trigger the trap 50.

Effectively, the mole trap 50 in accordance with this alternate embodiment has its U-shaped members 19 and 21 the same distance down relative to the mole tunnel 22, but is adapted to have a push-up pan 52 so that the mole trap 50 is fired or triggered when the mole 23 or earth moved by the mole 23 pushes upwardly in the vertical cylindrical cavity or hole 14 over the mole tunnel 22.

The various components which are common to both embodiments 20 and 50 have the same reference numerals.

Preferably, but not necessarily, at least the lower parts of the trigger mechanisms 16 and 51 may be fabricated of wood or plastic to avoid the mole 23 from smelling same.

The hole 14 and the hole-cutting member 13 may have shapes other than cylindrical, e.g., square, rectangular, etc.

Preferably, but not necessarily, the mole trap 20 or 50 may be provided with an inverted U-shaped safety handle 60 as shown in FIGS. 2, 3 and 5. The safety handle 60 is preferably secured to the top frame structure 30 over the guide rod bolts 35 and 36. The safety handle 60 prevents inadvertently getting the user's hand pinched between the top frame structure 30 and the guide rod bolts 35 and 36.

It should be understood that many changes, modifications, variations, and other uses and applications will become apparent to those persons skilled in this particular area of technology and to others after having been exposed to the present patent specification and accompanying drawings.

Any and all such changes, modifications, variations and other uses and applications which do not depart from the spirit and scope of the present invention are therefore covered by and embraced within the present invention, the present patent application, and the patent claims set forth hereinbelow.

1. A mole trap, comprising:
a first frame structure having a plurality of spikes rigidly depending therefrom;
said first frame structure being adapted to be disposed horizontally on the ground above a mole tunnel;
a second frame structure selectively and releasably connected to said first frame structure to slide linearly and vertically relative to said first frame structure;
a spring mechanism disposed substantially horizontally between said first frame structure and said second frame structure;
said second frame structure including two U-shaped members adapted to be placed in the ground transverse to and extending beneath said mole tunnel;
said first frame structure having a movable trigger mechanism at least a portion of which depends from said first frame structure and being adapted to extend in the vicinity of said mole tunnel;
said second frame structure including a moveable latch adapted to be engaged with said trigger mechanism when said spring mechanism is compressed; and
said trigger mechanism being instantly disengaged from said latch when a mole or earth moved by the mole touches a portion of said trigger mechanism, and thereby thrusting said two U-shaped members upwardly with the mole to impale the mole on said spikes.

2. A mole trap according to claim 1, wherein:
said trigger mechanism includes a swingable pendulum trigger.

3. A mole trap according to claim 1, wherein:
said trigger mechanism includes a pan member which is disposed in a hole above said mole tunnel; and
said pan member is connected to a push rod which is movable in a guide tube to fire said mole trap when the mole or earth moved by the mole pushes upwardly in said hole above said mole tunnel.

4. A mole trap according to claim 1, including:
a safety handle affixed to said second frame structure.

5. A mole trap according to claim 2, including:
a safety handle affixed to said second frame structure.

6. A mole trap according to claim 3, including:
a safety handle affixed to said second frame structure.

7. A device for facilitating a mole trap process and for facilitating setting of said mole trap according to claim 1 wherein said device comprises:
a main horizontal platform member from which depends a central hole-cutting member for cutting a substantially vertical hole in the ground into which at least a portion of said trigger mechanism may be disposed; and
two depending outer members for cutting slots in the ground to accommodate said U-shaped members.

8. A device according to claim 7, wherein:
said device is placed on the ground with said central hole-cutting member positioned over said mole tunnel and pressed downwardly to cut said substantially vertical hole into said mole tunnel, and at the same time to cut said slots in the ground.

9. A device according to claim 8, wherein:
after said hole and slots have been cut, said device is removed from the ground with an earth plug in said hole-cutting member and the earth plug is discarded;
said device is then re-positioned in said hole and slots to be used as a setting-assistance device to set said mole trap;
said mole trap is then placed on said device and set by compressing said spring mechanism and setting said trigger mechanism; and
after the mole trap has been set, said mole trap is removed from said device and positioned into said hole and said slots which were cut by said device.

10. A device for facilitating a mole trap process and for facilitating setting of said mole trap according to claim 3, wherein said device comprises:
a main horizontal platform member from which depends a central hole-cutting member for cutting a substantially vertical hole in the ground into which at least a portion of said trigger mechanism may be disposed; and
two depending outer members for cutting slots in the ground to accommodate said U-shaped members.

11. A device according to claim 10, wherein:
said device is placed on the ground with said central hole-cutting member positioned over said mole tunnel and pressed downwardly to cut said substantially vertical hole into said mole tunnel, and at the same time to cut said slots in the ground.

12. A device according to claim 1 wherein:
after said hole and slots have been cut, said device is removed from the ground with an earth plug in said hole-cutting member and the earth plug is discarded;
said device is then re-positioned in said hole and slots to be used as a setting-assistance device to set said mole trap;
said mole trap is then placed on said device and set by compressing said spring mechanism and setting said trigger mechanism; and
after the mole trap has been set, said mole trap is removed from said device and positioned into said hole and said slots which were cut by said device.

13. A mole trapping system, comprising:
first means for simultaneously making predetermined slots and a central hole in the ground in proximity to a mole tunnel in the ground;
a mole trap which is set by positioning said mole trap on said first means, compressing a spring mechanism of said mole trap, and latching a trigger mechanism of said mole trap;
after said mole trap has been set, removing said mole trap from said first means;
placing said mole trap over the mole tunnel with components of said mole trap fitting into said predetermined slots made by said first means, and with a portion of said trigger mechanism fitting into said central hole made by said first means; and
said trigger mechanism is released when a mole or earth moved by the mole comes in contact with said trigger mechanism sending said components upwardly carrying the mole towards spikes of said mole trap.

14. A system according to claim 13, wherein:
said trigger mechanism includes a swingable pendulum trigger.

15. A system according to claim 13, wherein:
said trigger mechanism includes a pan member which is disposed in said central hole above said mole tunnel; and
said pan member is connected to a push rod which is movable in a guide tube to fire said mole trap when the mole or earth moved by the mole pushes upwardly in said central hole above said mole tunnel.

16. A system according to claim 13, including:
a safety handle affixed to an upper portion of said mole trap.

17. A system according to claim 14, including:
a safety handle affixed to an upper portion of said mole trap.

18. A system according to claim 15, including:
a safety handle affixed to an upper portion of said mole trap.

19. A system according to claim 13, wherein:
said first means comprises a device for facilitating the mole trap process and for facilitating setting of said mole trap;
said device includes a main horizontal platform member from which depends a central hole-cutting member for cutting a substantially vertical hole in the ground into which at least a portion of said trigger mechanism may be disposed; and
two depending outer members for cutting said predetermined slots in the ground to accommodate said components which are U-shaped members.

20. A system according to claim 14, wherein:
said first means comprises a device for facilitating the mole trap process and for facilitating setting of said mole trap;
said device includes a main horizontal platform member from which depends a central hole-cutting member for cutting a substantially vertical hole in the ground into which at least a portion of said trigger mechanism may be disposed; and
two depending outer members for cutting said predetermined slots in the ground to accommodate said components which are U-shaped members.
